(19) United States
(12) Patent Application Publication
(10) Pub. No.: US 2015/0048986 A1
(43) Pub. Date: Feb. 19, 2015

(54) ANTENNA UNIT

(71) Applicant: ASUSTeK COMPUTER INC., TAIPEI (TW)

(72) Inventors: Shih-Hsuan HUANG, TAIPEI (TW); Tsung-Han CHENG, TAIPEI (TW)

(21) Appl. No.: 14/451,424

(22) Filed: Aug. 4, 2014

(30) Foreign Application Priority Data
Aug. 14, 2013 (TW) 102129152

(51) Int. Cl. H01Q 7/06

(52) U.S. Cl. CPC H01Q 7/06
USPC 343/788

(57) ABSTRACT

An antenna unit applied to an electronic device is provided. The antenna unit includes an input/output (I/O) element, a conductive wire and a magnetic material. The outer surface of the input/output element has a spiral groove. The conductive wire is disposed in the spiral groove of the input/output element. The magnetic material may be adhered above or/and under the conductive wire according to different designs. Thus, the conductive wire is insulated from the metal of environment or the input/output element.

### CROSS-REFERENCE TO RELATED APPLICATION

This application claims the priority benefit of Taiwan application serial No. 102129152, filed on Aug. 14, 2013. The entirety of the above-mentioned patent application is hereby incorporated by reference herein and made a part of specification.

### BACKGROUND OF THE INVENTION

1. Field of the Invention

The invention relates to an antenna unit and, more particularly, to an antenna unit for an electronic device.

2. Description of the Related Art

As science technology develops, Near Field Communication (NFC) technology is widely used. For example, a user can use NFC for data transmission, shopping payment, identity authentication or advertisement display, and a smart phone with an NFC antenna becomes more and more popular.

FIG. 1 is a top view showing a conventional NFC antenna unit 200. The conventional NFC antenna unit 200 is a flexible printed circuit (FPC) 220 including multiple coils of a conductive wire 210. The conductive wire 210 is disposed at the FPC 220, and two ends of the conductive wire 210 are electrically connected to an antenna signal input end 232 and an antenna signal output end 234 of an electronic device (such as a smart phone), respectively.

In assembly, the NFC antenna unit 200 is usually disposed at a back cover or a battery cover of the electronic device. When the user uses the electronic device with an NFC antenna unit 200, he or she only needs to put the back side (the back cover or the battery cover) of the electronic device near an NFC sensing device to be sensed. However, when the size of the back cover or the battery cover of the electronic device is small, such as a double-screen mobile phone which includes two screens at both sides, it is difficult to allocate the NFC antenna unit 200 on the electronic device which is inconvenience to the user.

### BRIEF SUMMARY OF THE INVENTION

An antenna unit applied to an electronic device is provided.

The antenna unit includes an input/output element, a conductive wire and a magnetic material. A spiral groove is formed at an outer surface of the input/output element. The conductive wire is disposed in the spiral groove of the input/output element. The magnetic material may be adhered above or/and under the conductive wire according to metal of relating components and environment. For example, the conductive wire is disposed between the magnetic material and the input/output element. Thus, the conductive wire is insulated from the metal of environment or the input/output element.

Since the spiral groove is formed at the outer surface of the input/output element, the conductive wire is fixed in the spiral groove of the input/output element by coiling. Furthermore, the input/output element may be one of the components of the electronic device, and thus the antenna unit only occupies a small space in the electronic device. The antenna unit takes place of the conventional FPC, and it does not need to be attached to a casing (such as the back cover or the battery cover) of the electronic device. Since the size of the casing of the electronic device is kept small, various designs of the electronic device can be more flexible.

These and other features, aspects and advantages of the present invention will become better understood with regard to the following description, appended claims, and accompanying drawings.

### BRIEF DESCRIPTION OF THE DRAWINGS

FIG. 1 is a top view showing a conventional NFC antenna unit;

FIG. 2 is a three-dimension schematic diagram showing an antenna unit in an embodiment applied to an electronic device;

FIG. 3 is a three-dimension schematic diagram showing the antenna unit in FIG. 2;

FIG. 4 is a three-dimension schematic diagram showing the antenna unit FIG. 3 without a magnetic material;

FIG. 5 is a partial enlarged view showing the conductive wire at the outer surface of an input/output element in FIG. 4;

FIG. 6 is a three-dimension schematic diagram showing an antenna unit applied to an electronic device in another embodiment;

FIG. 7 is a three-dimension schematic diagram showing the antenna unit in FIG. 6; and

FIG. 8 is a three-dimension schematic diagram showing the antenna unit in FIG. 7 without a magnetic material.

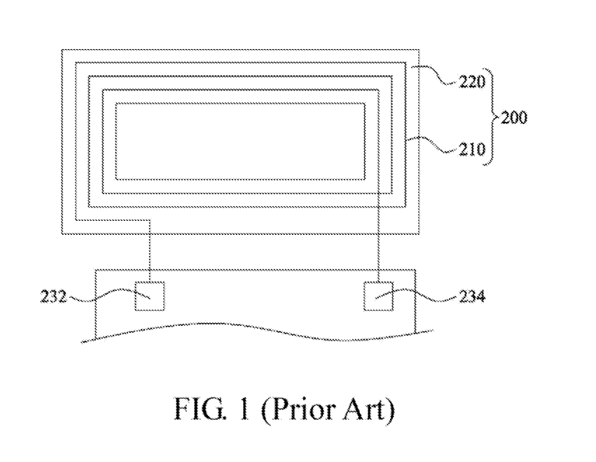

### DETAILED DESCRIPTION OF THE EMBODIMENTS

An antenna unit is illustrated with relating figures, and the same symbols denote the same components.

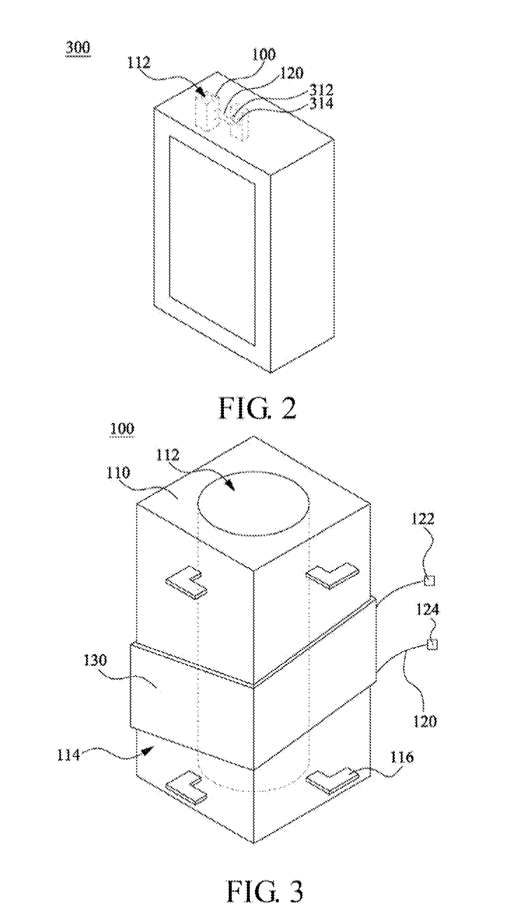

FIG. 2 is a schematic diagram showing an antenna unit 100 in an embodiment applied to an electronic device 300. FIG. 3 is a schematic diagram showing the antenna unit 100 in FIG. 2.

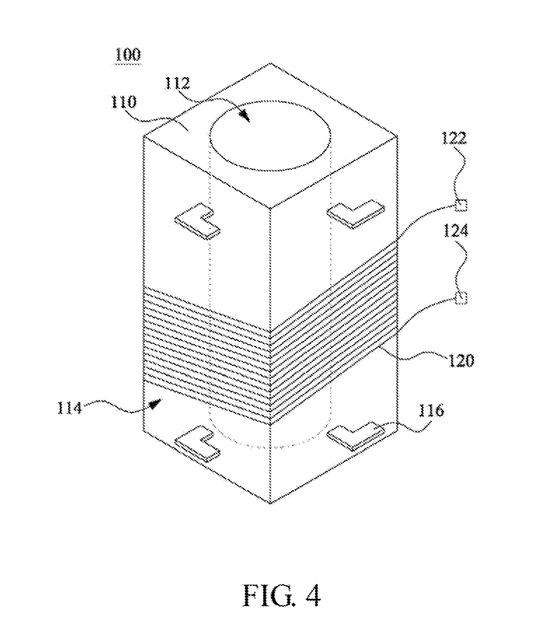

Please refer to FIG. 2 and FIG. 3, the antenna unit 100 is applied to the electronic device 300. The antenna unit 100 includes an input/output element 110, a conductive wire 120 and a magnetic material 130. The conductive wire 120 is wound at an outer surface 114 of the input/output element 110 (as shown in FIG. 4). The magnetic material 130 is flexible and attached to the conductive wire 120 along the outer surface 114 of the input/output element 110. Thus, the conductive wire 120 is between the magnetic material 130 and the input/output element 110. Two ends 122 and 124 of the conductive wire 120 are pulled out from the magnetic material 130, and they are electrically connected to an antenna signal input end 312 and an antenna signal output end 314 of the electronic device 300, respectively.

The antenna unit 100 may be an NFC element. The magnetic material 130 may include a soft ferrite material and other magnetic materials. In using, the magnetic material 130 can make signals distribute uniformly and insulate the antenna unit 100 from the metal components of the electronic device 300, and thus it can reinforce magnetic field intensity of the antenna unit 100 effectively and expand a sensing range of an NFC sensing device. The NFC sensing device may be a data transmission device, a shopping payment device, an identity authentication device or an advertisement display device, as long as the NFC device can be wirelessly connected to the NFC sensing device of the electronic device 300, the NFC sensing device is not limited herein.

However, the magnetic material 130 of the antenna unit 100 can be selectively disposed according to metal components of the electronic device or the environment. That is, when it is not needed to insulate the antenna unit 100 from metal components, the magnetic material 130 is not needed.

In the embodiment, the input/output element 110 may be an audio transmission port (such as an earphone connecting port), and it includes an earphone inserting hole 112 and a plurality of electrodes 116. The earphone inserted into the earphone inserting hole 112 is electrically connected to audio devices of the electronic device 300 via the electrodes 116, so the earphone can receive signals from the audio devices via the input/output element 110. The input/output element 110 may also be a video transmission port (such as a high-definition multimedia interface (HDMI) connecting port), a data transmission port (such as a universal serial bus (USB) connecting port) or a button (such as a volume button, a power button or a camera shutter button), which is not limited herein.

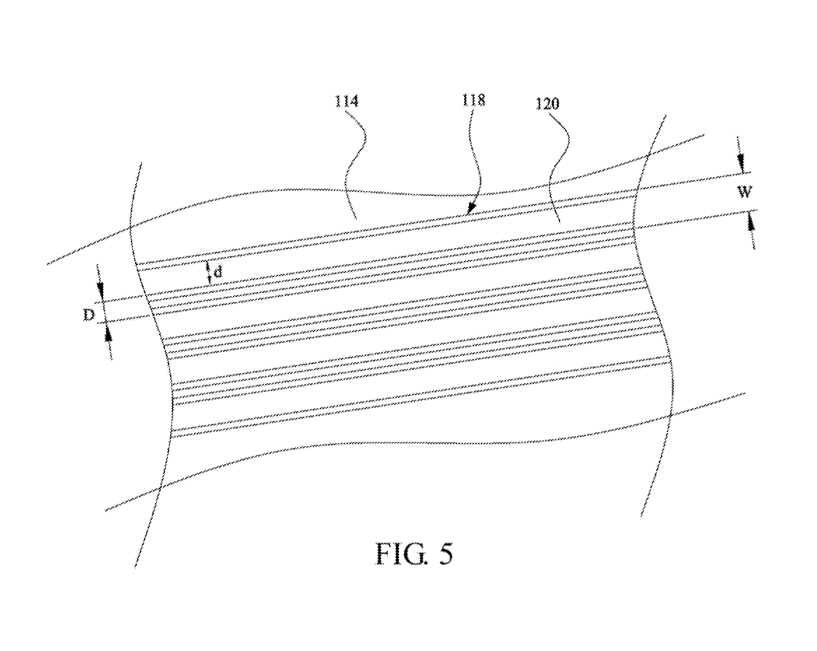

FIG. 4 is a schematic diagram showing the antenna unit 100 in FIG. 3 without the magnetic material 130. FIG. 5 is a partial enlarged view showing the conductive wire 120 disposed at the outer surface 114 of the input/output element 110 in FIG. 4. Please refer to FIG. 4 and FIG. 5, a spiral groove 118 is formed at the outer surface 114 of the input/output element 110. The conductive wire 120 is wounded in the spiral groove 118 of the outer surface 114 of the input/output element 110. The spiral groove 118 may be formed at the outer surface 114 of the input/output element 110 via laser engraving or molding, which is not limited herein. A minimum value of a coil distance D is limited by the manufacturing method of the spiral groove 118.

In the embodiment, number of turns of the spiral groove 118 is equal to that of the conductive wire 120. That means, the conductive wire 120 is not overlapped to each other in wounding, and the position of the conductive wire 120 corresponds to that of the spiral groove 118, so as to avoid errors due to different wounding ways. When the antenna unit 100 is an NFC antenna unit, the turns of the conductive wire 120 and the spiral groove 118 at the outer surface 114 of the input/output element 110 are between 3 to 50. When the turns of the conductive wire 120 at the input/output element 110 are larger than 15, the sensing range of the antenna unit 100 corresponding to the NFC sensing device is narrowed along with the increase of the turns of the conductive wire 120. Manufacturers adjust the sensing range of the antenna unit 100 by changing the turns of the conductive wire 120 at the input/output element 110.

Moreover, the coil distance D of the conductive wire 120 at the input/output element 110 is between 0.01 mm to 2 mm, such as 0.015 mm, which is not limited herein. The smaller the coil distance D of the conductive wire 120 is, the larger a sensing value is, and a sensing intensity of the antenna unit 100 corresponding to the NFC sensing device becomes higher. Thus, the coil distance D can be adjusted according to a matching state of the antenna unit 100 and the NFC sensing device in communication to meet an application frequency.

When the antenna unit 100 is under manufacturing, the turns, the wire width d (or the wire diameter) and the coil distance D of the conductive wire 120 can be determined according to different sensing value and the sensing range of the antenna unit 100. The wire width d of the conductive wire 120 may be between 0.01 mm to 0.5 mm, which is not limited herein.

The width W of the spiral groove 118 may be larger than or equal to the wire width d of the conductive wire 120. When the width W nearly equals to the wire width d of the conductive wire 120, a distance between two adjacent grooves 118 equals to the coil distance D. The width W and the depth of the spiral groove 118 are determined according to the wire width d of the conductive wire 120. Since the spiral groove 118 relates to the turns, the wire width d and the coil distance of the conductive wire 120, the antenna unit 100 can still be designed according to a sensing value.

Since the spiral groove 118 is formed at the outer surface 114 of the input/output element 110, the conductive wire 120 is disposed in the spiral groove 118 of the input/output element 110 by wounding. In usage, the user only needs to put the antenna unit 100 (such as an earphone connecting port) of the electronic device 300 near the NFC sensing device to be sensed.

The input/output element 110 can be an earphone connecting port, an HDMI connecting port, an USB connecting port, a volume button, a power button or a camera shutter button of the electronic device 300, consequently, the antenna unit 100 only occupies a little space of the electronic device 300, and it does not need to be attached to a casing (such as a back cover or a battery cover) of the electronic device 300. Since the size of the casing of the electronic device 300 is kept small, the design of the electronic device 300 can be more flexible.

For example, when the electronic device 300 is a double-screen phone which includes screens at a front side and a rear side of the electronic device 300 respectively, the antenna unit 100 does not need to be fixed at the casing of the electronic device 300 and occupy the disposing position of the screen. The antenna unit 100 can be disposed at an audio transmission port of the electronic device 300, which saves cost and space in the electronic device 300.

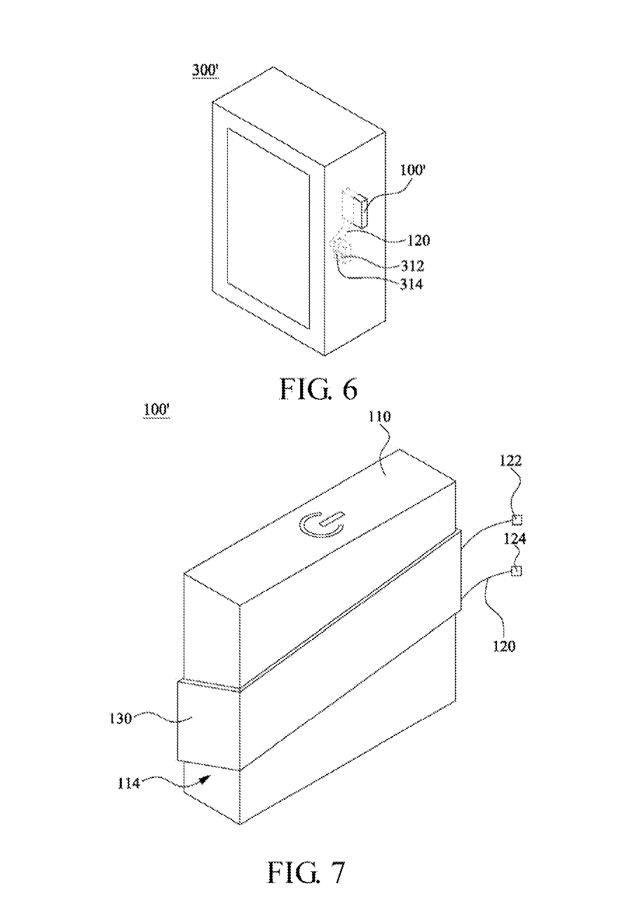

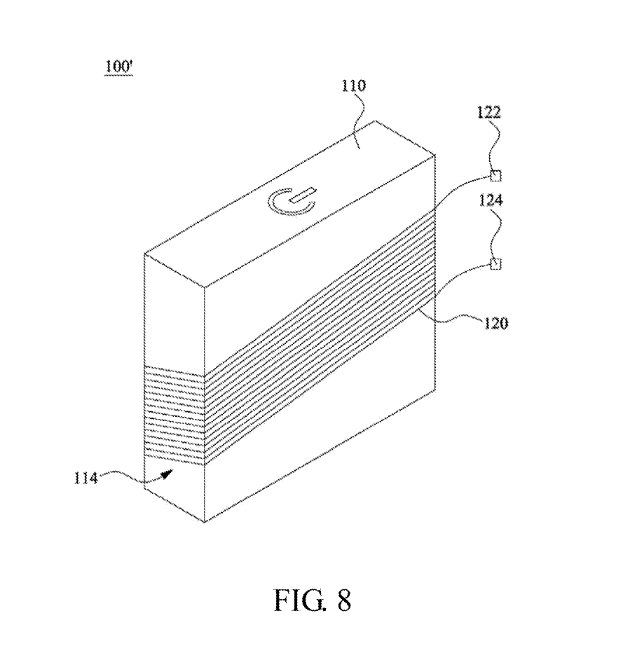

FIG. 6 is a schematic diagram showing an antenna unit 100′ applied to an electronic device 300′ in another embodiment. FIG. 7 is a schematic diagram showing the antenna unit 100′ in FIG. 6. FIG. 8 is a schematic diagram showing the antenna unit 100′ in FIG. 7 without a magnetic material 130. Please refer to FIG. 6 to FIG. 8, the antenna unit 100′ includes the input/output element 110, the conductive wire 120 and the magnetic material 130. The conductive wire 120 is wounded at the outer surface 114 of the input/output element 110. The two ends 122 and 124 of the conductive wire 120 can be pulled out from the magnetic material 130 and electrically connected to the antenna signal input end 312 and the antenna signal output end 314 of the electronic device 300′, respectively.

The difference between this embodiment and the embodiment shown in FIG. 2 to FIG. 4 is that the input/output element 110 of the antenna unit 100′ is a button, but not an audio transmission port. In the embodiment, the input/output element 110 may be a power button.

The outer surface 114 of the input/output element 110 of the antenna unit 100′ also has the spiral groove 118 as shown in FIG. 5, and the conductive wire 120 is disposed in the spiral groove at the outer surface 114 of the input/output element 110. In the embodiment, the structure of the spiral groove is similar with that in FIG. 5, which is omitted herein. In using, the user only needs to put the antenna unit 100′ (such as the power button) of the electronic device 300′ near the NFC sensing device to be sensed.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. An antenna unit applied to an electronic device, the antenna unit comprising:
an input/output element, wherein a spiral groove is formed at an outer surface of the input/output element;
a conductive wire disposed in the spiral groove of the input/output element; and
a magnetic material attached to the conductive wire, wherein the conductive wire is disposed between the magnetic material and the input/output element.

2. The antenna unit according to claim wherein turns of the conductive wire are between 3 to 50.

3. The antenna unit according to claim 1, wherein a distance between coils of the conductive wire is between 0.01 mm to 2 mm.

4. The antenna unit according to claim 1, wherein the spiral groove is formed via laser engraving or molding.

5. The antenna unit according to claim 1, wherein the antenna unit is a near-field communication (NFC) element.

6. The antenna unit according to claim 1, wherein the magnetic material includes a soft ferrite material.

7. The antenna unit according to claim 1, wherein the input/output element is an audio transmission port, a video transmission port, a data transmission port or a button.

8. The antenna unit according to claim 1, wherein two ends of the conductive wire are electrically connected to a signal input end and a signal output end of the electronic device, respectively.
